(19) United States
(12) Patent Application Publication
(10) Pub. No.: US 2009/0163158 A1
(43) Pub. Date: Jun. 25, 2009

(54) SUPPORT OF DOWNLINK DUAL CARRIERS AND OTHER FEATURES OF EVOLVED GERAN NETWORKS

(75) Inventors: Prabhakar R. Chitrapu, Blue Bell, PA (US); Marian Rudolf, Montreal (CA); Behrouz Aghili, Melville, NY (US); Yan Li, Center Valley, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/186,141

(22) Filed: Aug. 5, 2008

Related U.S. Application Data
(60) Provisional application No. 60/954,400, filed on Aug. 7, 2007.
(60) Provisional application No. 60/965,630, filed on Aug. 20, 2007.

(51) Int. Cl. H04B 1/04; H04W 4/00; H04J 3/00

(52) U.S. Cl. 455/127.5; 370/329; 370/336

(57) ABSTRACT

A wireless transmit receive unit (WTRU) configured to indicate REDHOT and HUGE multi-slot capability to a network. The REDHOT multi-slot capability is included in a MS Classmark 3 information element and a MS Radio Access Capability information element. In another embodiment, DLDC operation in an evolved GERAN system includes both single carrier and dual carrier modes. Monitoring in single carrier mode reduces battery consumption. Various techniques for enabling dual carrier mode are disclosed.

### CROSS REFERENCE TO RELATED APPLICATIONS

This application claims the benefit of U.S. Provisional Application Nos. 60/954,400 filed Aug. 7, 2007 and 60/965,630 filed Aug. 20, 2007, respectively, and are incorporated by reference as if fully set forth.

### TECHNICAL FIELD

The subject matter disclosed herein relates to wireless communications.

### BACKGROUND

Global System for Mobile Communications (GSM) Enhanced Date Rate for GSM Evolution (EDGE) Radio Access Network (GERAN) evolution is the ongoing enhancement of existing GSM and EDGE based cellular network standards. Several notable enhancements include downlink dual carrier (DLDC) capability, latency reduction (LATRED), including reduced transmission time interval (RTTI) and fast ACK/NACK reporting (FANR) features, enhanced general packet radio service 2 (EGPRS-2) features including reduced symbol duration higher order modulation and turbo coding (REDHOT) which includes higher order modulation, high symbol rate, and turbo-coding on the downlink, and the higher uplink performance for GERAN evolution (HUGE) feature.

Latency Reduction (LATRED) is designed to reduce transmission delays, increase data throughput, and to provide better Quality-of-Service (QoS). LATRED consists of two techniques. The first LATRED technique is reduced transmission time interval (RTTI) mode of operation. The second LATRED technique is fast acknowledgement/non-acknowledgement (ACK/NACK) reporting (FANR) mode of operation.

Both the RTTI feature and the FANR feature may either work separately or in conjunction with each other. Furthermore, both the RTTI feature and the FANR feature may be used in conjunction with the EGPRS modulation-and-coding schemes MCS-1 to MCS-9 (except for MCS-4 and MCS-9 where FANR mode of operation is not possible), or with the novel Release 7 and beyond EGPRS-2 modulation-and-coding schemes DAS-5 to DAS-12, DBS-5 to DBS-12, UAS-7 to UAS-11 and UBS-5 to UBS-12. Both the RTTI and the FANR modes of operation are also possible with DLDC and Downlink Advanced Receiver Performance (DARP) operation.

Referring to FIG. 1, a high level GERAN network architecture 100 is shown. A wireless transmit/receive unit (WTRU) 105 communicates with a base station 110 via an air interface 115. The base station 110 communicates with a base station controller (BSC) 120 via a wired interface. The base station 110 and the BSC 120 form a base station subsystem (BSS) 125. The BSS 125 communicates with a mobile switching center 130 and a general packet radio service (GPRS) core network (CN) 135 via a wired interface with to the BSC 120. The MSC 130 provides switching services to connect with other mobile networks as well as traditional wireline telephone networks, such at the public switched telephone network (PSTM) 140. The GPRS CN 135 provides data services to the WTRU 105 and includes a serving GPRS support node (SGSN) 145 and gateway GPRS support node (GGSN) 150. The GGSN 150 may connect to the Internet and other data service provides.

DLDC operation utilizes two radio frequency channels for uplink (UL) and/or downlink (DL) temporary block flows (TBFs) and/or dedicated resources for communications between a base station and WTRU. In packet switched (PS) mode, Radio Link Control/Multiple Access Control (RLC/MAC) blocks for UL TBFs are only transmitted on one radio frequency channel in a radio block period (known as “single carrier” mode), and RLC/MAC blocks for DL TBFs may be transmitted on two radio frequency channels in a radio block period (known as DLDC).

Since resource allocation in PS modes, such as GPRS and enhanced GPRS (EGPRS), is not symmetric, a WTRU may have available radio resources (i.e., TBFs), in the UL, the DL, or both the UL and the DL simultaneously. When a WTRU receives a DL TBF assignment, the WTRU monitors all DL Radio Blocks during assigned time slot(s) for Temporary Flow Identity (TFI) values corresponding to the assigned DL TBF in received headers. In the UL, a WTRU is assigned one or more time slots using corresponding UL State Flag(s) (USF). The WTRU monitors all DL Radio Blocks on the assigned time slot (s) and upon detection of the assigned USF, the WTRU then uses the next Radio Block for UL communication.

DLDC operation requires a WTRU to monitor two DL carriers simultaneously. Monitoring two DL carriers has an adverse effect on WTRU battery consumption. In single carrier modes, a WTRU monitors a DL Packet Data Channel (PDCH) and attempts to decode the RLC/MAC header portion of all radio blocks. Most of the time, however, since the same DL PDCH resource is shared by multiple WTRUs, this process is inefficient and consumes WTRU power resources. Extending this legacy EGPRS technique to DLDC operation, WTRU battery consumption is compounded because the WTRU must now monitor two DL carriers. The obvious solution of a WTRU monitoring only a single PDCH on a single carrier would greatly restrict flexibility and multiplexing gains for data transmissions in DLDC mode.

The implementation of DLDC in combination with Mobile Station Receive Diversity (MSRD), or DARP Phase II, capable WTRUs is particularly advantageous because duplicated radio frequency hardware in the WTRU for the purpose of receiving the second carrier in DLDC modes can be reused for MSRD operation. DLDC, as described above, represents distinct advantages in terms of scheduling efficiency by the network and achievable throughput rates between the network and a WTRU. MSRD, or DARP Phase II, allows for gains in terms if link robustness and reduced error rates, as well as interference reduction from the network side.

While MSRD may be implemented in a WTRU in various ways, typically two RF processing chains tune to and process a single carrier frequency. This prevents simultaneous DLDC implementation because the second RF chain is utilized for MSRD purposes and cannot tune to the second carrier for DLDC. A switching mechanism is therefore desired that permits DLDC monitoring and reception on two carriers and MSRD reception for signals received on a single carrier.

A WTRU may indicate various capabilities to a GSM or EGPRS network by transmitting a MS Classmark IE (Type 1, 2 or 3), a MS Radio Access Capability (MS RAC) IE, or a MS Network Capability (MS NW Capability) IE. These IEs contain the complete GSM/GPRS/EDGE capabilities of the WTRU.

When a service is setup in the circuit switched (CS) domain, a WTRU transmits a MS Classmark IE to the network. Typically, the WTRU transmits a “NAS CM Service Request” or a “RR Paging Response” message containing the MS Classmark IE to the network. When a service is setup in the packet switched (PS) domain, a WTRU transmits a MS RAC IE and a MS NW Capability IE to the network. Typically, the WTRU transmits an “Attach Request” or “Routing Area Update Request” message containing the MS RAC IE and the MS NW Capability IE to the network.

The MS Classmark IE may be one of three different types: type 1, 2, or 3. Referring to FIG. 2, each type of MS Classmark IE is a different length (number of octets) and carries different contents. A MS Classmark type 1 IE 210 contains one octet of information. MS Classmark type 1 210 is mandatory and is typically sent in non-access stratum (NAS) messages such as a “Location Update Request” message or an “IMSI Detach Indication” message. The MS Classmark type 1 IE 210 is completely contained in a MS Classmark type 2 IE 220 as octet three of five. The Classmark type 2 IE 220 contains a flag bit 230 indicating further availability of a MS Classmark type 3 IE 240. MS Classmark type 3 IE 240 is the longest MS Classmark IE type.

There are two ways for a network to obtain a MS Classmark type 3 IE. A MS Classmark type 3 may be contained in a radio resource (RR) “Classmark Change” message that is sent by a WTRU in response to receiving a Broadcast Control Channel (BCCH) System Information bit indicating the RR message is required. Alternatively, the network may poll a WTRU via a RR “Classmark Enquiry” message. The WTRU may answer by the poll by sending the “Classmark Change” message.

The NAS Attach Request message contains the MS NW Capability IE and the MS RAC IE. The NAS Attach Request message is typically transmitted from a WTRU upon GPRS core network (CN) entry. A serving GPRS support node (SGSN) typically forwards the MS RAC IE to a base station subsystem (BSS). The MS NW Capability IE is more relevant to the core network and is typically not forwarded to the BSS.

A prior art GERAN evolution, or GSM/EGRPS compliant, WTRU indicates support of DLDC capability implicitly by indicating new multi-slot capabilities for operation in dual carrier mode. DLDC capability of the WTRU is indicated to the network along with the EGPRS multi-slot capability in dual carrier mode. In addition to bits indicating the multi-slot class of the WTRU (which in turn indicates the maximum number of UL timeslots and DL timeslots the WTRU is capable of handling), a three bit capability field present in the MS Classmark Type 3 and MS RAC IE signals a reduction in the maximum number of timeslots for the dual carrier capability. The field is coded as follows:

| Bits 3 2 1 | Action |
|---|---|
| 0 0 0 | No reduction |
| 0 0 1 | The MS supports 1 timeslot fewer than the maximum number |
| | of receive timeslots |
| 0 1 0 | The MS supports 2 timeslots fewer than the maximum number |
| | of receive timeslots |
| 0 1 1 | The MS supports 3 timeslots fewer than the maximum number |
| | of receive timeslots |
| 1 0 0 | The MS supports 4 timeslots fewer than the maximum number |
| | of receive timeslots |
| 1 0 1 | The MS supports 5 timeslots fewer than the maximum number |
| | of receive timeslots |
| 1 1 0 | The MS supports 6 timeslots fewer than the maximum number |
| | of receive timeslots |
| 1 1 1 | Reserved for future use |

Additionally, an indication of whether DLDC is supported for EGPRS dual transfer mode (DTM) is included in the MS Classmark Type 3 and MS RAC IE. The DLDC for DTM capability field is a one bit field that indicates whether a WTRU supports DTM and DLDC simultaneous operation. The field is coded as follows:

Bit

| | |
|---|---|
| 0 | The mobile station does not support DTM during DLDC operation |
| 1 | The mobile station does support DTM during DLDC operation |

If a WTRU supports DTM and DLDC operation as indicated by bit 1 of this field, the Multi-slot Capability Reduction for DLDC field provided in the MS Radio Access Capability IE is applicable to EGPRS DTM support as well and shall contain the same value as the Multi-slot Capability Reduction for DLDC field provided in the MS Classmark 3 IE.

The EGPRS LATRED capability field is a one bit field indicating WTRU support for RTTI configurations and FANR.

Bit

| | |
|---|---|
| 0 | The mobile station does not support RTTI configurations and FANR |
| 1 | The mobile station does support RTTI configurations and FANR |

EGPRS-2 features REDHOT, or EGPRS-2 DL, and HUGE, or EGPRS-2 UL, are separate capabilities. A WTRU may implement different levels of REDHOT and HUGE (levels A, B, and C) separately. Combinations, such as a WTRU implementing REDHOT A, or EGPRS-2A DL and HUGE B, or EGPRS-2B UL are possible. Even with REDHOT or HUGE, Latency reduction capability (RTTI and FANR) must automatically work with EGPRS and new standard releases, and not just with EDGE compliant networks.

REDHOT and HUGE increase average data rates significantly compared to legacy GPRS and EDGE. When a WTRU signals its Multi-slot Capability to the network, for example five receive (Rx) and two transmit (Tx) timeslots per frame, the WTRU would then theoretically be required to be able to receive, demodulate and decode REDHOT bursts on all five Rx timeslots. However, the WTRU may have difficulty coping with the increased data reception rates due to limited base-band resources. To facilitate gradual introduction of a REDHOT capable WTRUs into the market, it is desirable to allow for reduced REDHOT timeslot operation. For example, a WTRU may signal five Rx timeslots, indicated by its EGPRS multi-slot class, but only three Rx timeslots out of five can be used by the network in any given frame for REDHOT bursts sent to the WTRU.

In addition to the processing constraints, increased modulation order and radio frequency filter requirements, other factors affect power consumption and thermal dissipation. In the case of HUGE, this may result in thermal constraints that prevent the WTRU from full transmit timeslot operation as specified by the currently existing (E)GPRS multi-slot class definitions. Similarly, a reduced set of transmit multi-slots (as compared to legacy EGPRS multi-slot classes) would allow for gradual deployment and gradual upgrades for processing resources while allowing for the higher radio efficient mode of operation provided by EGPRS-2 features HUGE and REDHOT.

Due to the nature of REDHOT and HUGE, that is, the use of higher order modulation as well as higher symbol rate, interference and adjacent channel interference are important issues to be considered by network operators. Operating at higher frequencies may also lead to higher power consumption.

Due to the increasing demands placed on WTRU resources by GERAN evolution, including DLDC, REDHOT, and HUGE operating modes, mechanisms for allocating resources and indicating capabilities are desired.

### SUMMARY

A wireless transmit receive unit (WTRU) configured to indicate REDHOT and HUGE multi-slot capability to a network. The REDHOT multi-slot capability is included in a MS Classmark 3 information element and a MS Radio Access Capability information element. In another embodiment, DLDC operation in an evolved GERAN system includes both single carrier and dual carrier modes. Monitoring in single carrier mode reduces battery consumption. Various techniques for enabling dual carrier mode are disclosed.

### BRIEF DESCRIPTION OF THE DRAWINGS

FIG. 1 is a block diagram of a GSM EDGE radio access network.

FIG. 2 is an illustration of MS Classmark IE.

FIG. 3A is a flow diagram of a method of allocating carriers in DLDC mode.

FIG. 3B is a signal diagram of a method of allocating carriers in DPDC mode.

FIG. 4 is a flow diagram of a method of dynamically determining and signaling WTRU capabilities to a network.

FIG. 5 is a block diagram of a WTRU and a base station.

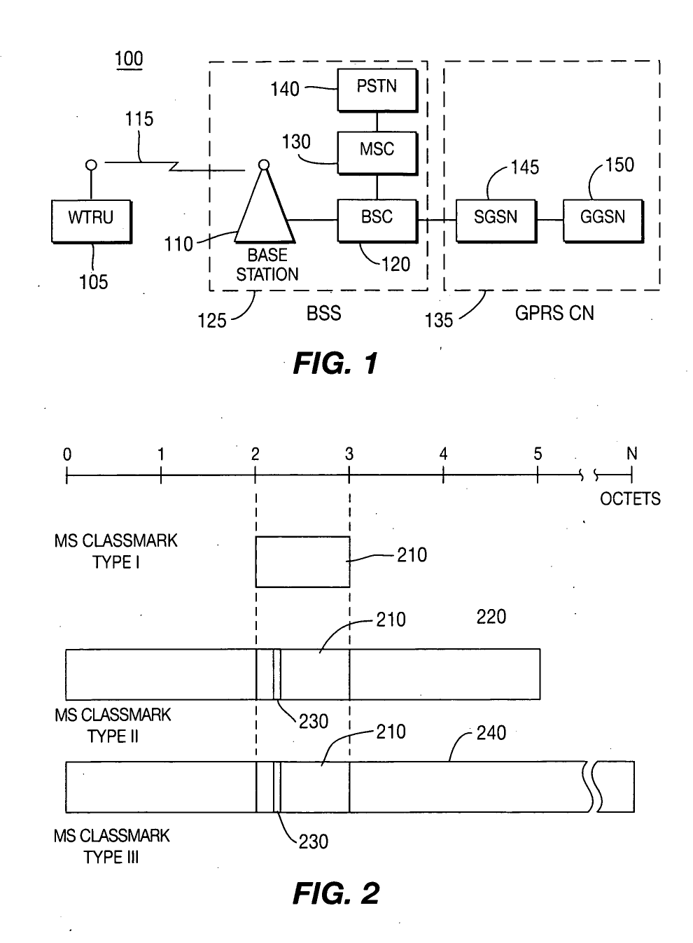

### DETAILED DESCRIPTION

When referred to herein, the terminology “wireless transmit/receive unit (WTRU)” includes but is not limited to a user equipment (UE), a mobile station (MS), a fixed or mobile subscriber unit, a pager, a cellular telephone, a personal digital assistant (PDA), a computer, or any other type of user device capable of operating in a wireless environment. When referred to herein, the terminology “base station” includes but is not limited to a Node-B, a site controller, an access point (AP), or any other type of interfacing device capable of operating in a wireless environment.

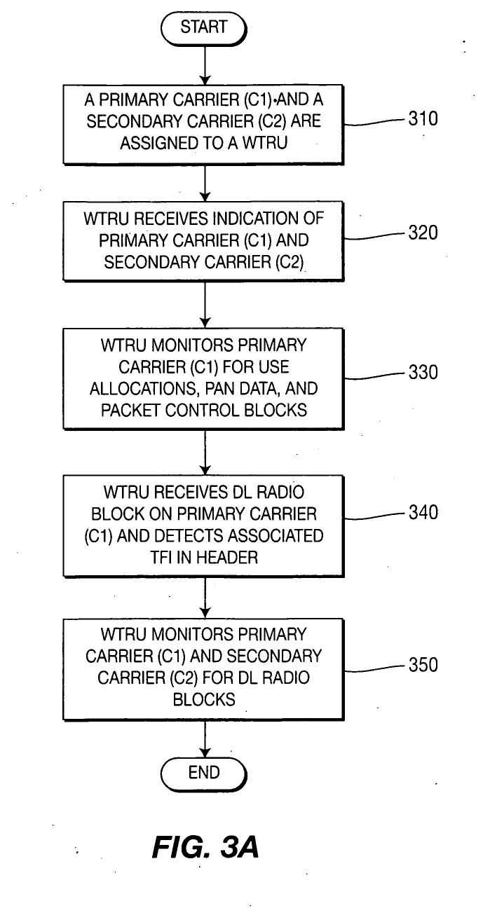

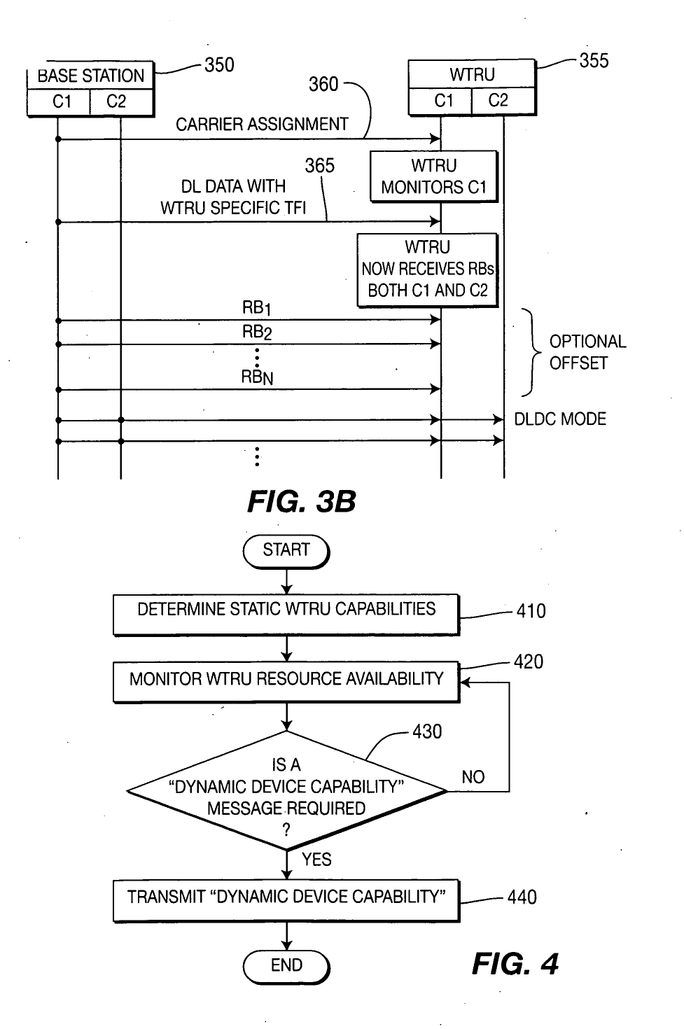

In one embodiment, referring to FIG. 3A, a WTRU is assigned two separate carriers, a primary carrier (C1) and a secondary carrier (C2), (step 310). The WTRU receives from the network an indication as to which carrier is the primary carrier (C1) and which is the secondary carrier (C2), (step 320). It is noted that the assignment of the primary carrier (C1) and the secondary carrier (C2) may be made in any number of ways that will be apparent to those skilled in the art. Purely for example, the order in time of received packet assignments can implicitly indicate which carrier is the primary. Alternatively, again purely for example, an assignment message may contain an explicit designation of a carrier as C1 or C2. Extensions to the existing packet assignment message commonly used for legacy GPRS or (E)GPRS may be used for this purpose.

Following the designation of the primary carrier (C1) and the secondary carrier (C2), the WTRU will receive USF allocations, PAN data if present, and any Packet Control Blocks on the primary carrier (C1) only. The WTRU only monitors the primary carrier (C1) to receive any of the above messages, (step 330). This allows the WTRU and the network to temporarily revert to single carrier reception even though DLDC is still enabled. This results in decreased power consumption by the WTRU.

Subsequently, when DL data is ready to be sent and received by the WTRU, a first radio block is transmitted and received on the primary carrier (C1) and one or more subsequent radio blocks are transmitted and received on both the primary carrier (C1) and the secondary carrier (C2). The WTRU, which has only been monitoring the primary carrier (C1), will receive the first DL radio block and detect its own TFI in the header, (step 340). The WTRU then monitors both the primary carrier (C1) and the secondary carrier (C2) from the next radio block onwards in a typical DLDC implementation, (step 350). Accordingly, the WTRU will be able to receive all the DL radio blocks without missing any radio blocks while conserving power during idle periods. It is noted that the network may use any RLC/MAC block to initiate a switch of the WTRU to full DLDC reception mode (for example, RLC/MAC data blocks or control blocks/segments/messages).

Similarly, referring to FIG. 3B, a signal diagram showing DLDC operation according to one embodiment includes a base station 350 and a WTRU 355. On a primary carrier (C1) the base station 350 transmits a carrier assignment message to the WTRU 355, (step 360). Thereafter, the WTRU 355 monitors the primary carrier (C1). Upon receiving DL data including a WTRU specific TFI on the primary carrier (C1), (step 365) the WTRU begins DLDC operation and receives DL radio blocks on both the primary carrier (C1) and the secondary carrier (C2). The WTRU may begin receiving DL radio blocks using both the primary carrier (C1) and a secondary carrier (C2) immediately or after an optional offset. In the case where an optional offset is used, a plurality of radio blocks RB₁ . . . RBₙ are received on the primary carrier (C1) prior to receiving further DL radio blocks on both the primary carrier (C1) and the secondary carrier (C2) in full DLDC mode.

The optional offset may be predetermined or configurable, and may be known by both the network and the WTRU before hand or signaled. Alternatively, instead of transmitting on both the primary carrier (C1) and the secondary carrier (C2) after the offset described above, the DL data may be transmitted and received on the primary carrier (C1) alone, or the secondary carrier (C2) alone, or the primary carrier (C1) and the secondary carrier (C2) together, or not transmit on either carrier at all. The transmissions may switch dynamically between these four modes. While the WTRU is in a state of constantly monitoring both carriers (C1) and (C2), no DL data intended for the WTRU will be missed (except due to channel impairments).

The above methods may be combined by defining rules for WTRU and network behavior for switching between carriers C1 and C2 when in DLDC mode. For example, a rule may be defined that mandates a single carrier (SC) or a dual carrier (DC) reception mode for the WTRU during designated time periods, during certain frames in a multi-frame structure, or conditioned on occurrence of certain types of events. For example, the network may at the time of TBF assignment, signal to the WTRU a pattern of SC/DC modes. In the SC mode assignment, a particular carrier to be monitored may be signaled to the WTRU or predetermined. Various other events may be used to trigger transitions to and from SC and DC modes of DLDC operation. Purely for example, timer values since occurrence of last transmission received on both carriers or certain types of transmission received defining the timer, signaling bits received in parts of RLC/MAC headers, signaling messages received by the WTRU with an explicit switchover command may all be used to trigger transitions to and from SC and DC modes of DLDC operation. Generally, the goal of these modes is balancing the advantageous power consumption of SC mode with the improved performance of DC mode.

The assignment of SC and DC modes to a WTRU may be implemented in a variety of ways. Purely for example, the network may designate a number of Radio Blocks for each of the SC and DC modes. The beginning of the SC mode may be set by the network at a fixed offset from the TBF assignment message. Alternatively, the network may limit occurrences of certain frames/blocks in a multi-frame structure to certain types of operation only (i.e. designated SC and designated DC transmission opportunities). Changes to the assignment of the SC and DC modes may be changed within a TBF via a DL Packet Control Block.

The assignment of SC and DC modes may be done for each WTRU within a cell independently, for a subset of all WTRUs in a cell, or for all WTRUs within the cell at once, as desired.

Similarly, the above described methods may be applied to UL data. The single difference in applying the above described methods to UL data is the detection of an USF parameter being performed on the primary carrier (C1) and secondary carrier (C2) respectively in the DL by the WTRU, instead of TFI detection.

In another embodiment, dynamic device capabilities may be signaled by the WTRU to the network. Typically, as described in the Background, a WTRU signals its capabilities to a network. These capabilities are generally fixed capabilities defined by the hardware and software of the WTRU. These fixed capabilities include parameters such as power and multi-slot capability. Theses parameters are referred to as “static WTRU capabilities”, which set absolute limits to what the WTRU can send and receive.

GERAN Evolution introduces a number of new features to improve performance and function of a WTRU. These new features require additional WTRU resources including the hardware, software, memory, and power source, for example, battery capacity. There may be circumstances in which the WTRU is highly loaded and may not be able to support DL and UL communications up to the limits imposed by the “static WTRU capabilities”. Therefore, a WTRU may signal to the network a set of “dynamic device capabilities”. These “dynamic device capabilities” may change over time depending on available WTRU resources. The signaling may be performed on a periodic basis, in response to polling by the network, or upon the WTRU's initiation. Existing EGPRS protocols for UL data transfer may be used.

Referring to FIG. 4, a WTRU determines its static WTRU capabilities, (step 410). The WTRU then monitors resource availability, (step 420). The resources that are monitored may include hardware resources, such as memory, power consumption, heat dissipation, transmission power, battery resources, such as remaining battery life and projected power consumption, and radio resources. Based on various criteria that may be either predetermined or dynamic, the WTRU then determines whether a “dynamic device capability” message is required to be sent to the network, (step 430). Typically, a monitored parameter, or group of parameters, will exceed various thresholds triggering the “dynamic device capability” message. The WTRU will then transmit the “dynamic device capability” message to the network, (step 440). A network receiving the “dynamic device capability” message will utilize this information in UL and DL resource allocation.

Depending upon the availability of WTRU resources, a WTRU may reduce its multi-slot class, reduce a transmission power level, select a preferred set of frequencies or identify a set of frequencies to be avoided. The reduction of transmission power levels may be indicated as an absolute level or a value relative to a previous or known power level. Additionally, the ordering of modulation and coding scheme (MCS) classes may be adjusted, such that higher MCSs are associated with more demanding WTRU requirements. Certain MCS classes may be avoided altogether. All of the above are examples of parameters that may be modified by using a “dynamic device capability” message.

In another embodiment, a REDHOT multi-slot capability of a WTRU and a HUGE capability of a WTRU are contained in either a MS Classmark Type 3 IE or in a MS RAC IE, or in both. A REDHOT capable WTRU may explicitly signal its REDHOT multi-slot class in addition to its EGPRS multi-slot class. The current EGPRS multi-slot class definitions are modified using two different values fields. One value field is a multi-slot class value valid for EGPRS. The second value field is valid for at least one specific REDHOT level (level A or B) supported. Multiple second value fields may be used for different REDHOT levels. Alternatively, the second value field indicates support for both REDHOT levels (levels A and B). Similarly, one or more second value fields may be used for HUGE and its respective capability levels.

A REDHOT or HUGE capable WTRU may explicitly indicate a delta in its multi-slot support for REDHOT, as compared to what it would otherwise support according to its general multi-slot capabilities, and indicate the delta to the network. For example, a 3-bit field may indicate the receive multi-slot capability reduction of a dual carrier capable WTRU. The field may be coded as follows:

| Bits 3 2 1 | Action |
|---|---|
| 0 0 0 | No reduction |
| 0 0 1 | The MS supports 1 timeslot fewer than the maximum number |
| | of receive timeslots |
| 0 1 0 | The MS supports 2 timeslots fewer than the maximum number |
| | of receive timeslots |
| 0 1 1 | The MS supports 3 timeslots fewer than the maximum number |
| | of receive timeslots |
| 1 0 0 | The MS supports 4 timeslots fewer than the maximum number |
| | of receive timeslots |
| 1 0 1 | The MS supports 5 timeslots fewer than the maximum number |
| | of receive timeslots |
| 1 1 0 | The MS supports 6 timeslots fewer than the maximum number |
| | of receive timeslots |
| 1 1 1 | Reserved for future use |

Alternatively, the network or WTRU may be hard-coded with a relationship between EGPRS timeslot configurations and REDHOT or HUGE timeslot configurations. These hard-coded relationships may be predetermined or based on periodic signaling. The hard-coded relationship may define an admissible receive or transmit timeslot configuration allowable for use with REDHOT or HUGE as subsets or combinations or in relationship with one or more reference EGPRS timeslot configurations or valid combinations for other REDHOT levels.

Different hard-coded relationships, or multi-slot capability reductions, may be signaled between a WTRU and a network for each of the different REDHOT A and B and HUGE A, B, and C levels. The signaled relationships may be expressed either as a differential to an existing EGPRS multi-slot class or by a delta to another REDHOT or HUGE level.

The above hard-coded relationship may be applied to HUGE multi-slot capability as well. Of course, for HUGE the number and class of transmit timeslots, and not receive timeslots, would be indicated. Multi-slot reduction values signaled or coded by rule or procedure may apply to a given REDHOT or HUGE level, or they can apply to a subset of levels. Alternatively, they can apply to all REDHOT or HUGE levels implemented in a WTRU.

REDHOT or HUGE support by a WTRU is implied by the network when the WTRU indicates a REDHOT or HUGE multi-slot capability reduction, either per applicable level or per reference class chosen.

In another embodiment, a network may implement a static or configurable power offset value for base station transmissions to the WTRU in the DL, or signal a power offset value for UL transmissions by a WTRU for EGPRS-2 transmissions. The power offset value may be signaled in a broadcast manner using a System Information message, or during resource allocation for packet UL assignment. The power offset value may also be hard-coded in a set of rules known to the base station and WTRU. As an example, a WTRU is ready to transmit information in the UL using 16 quadrature amplitude modulation (16-QAM) and a high symbol rate. The power control mechanism determines that 21 dBm is to be used by the WTRU. With an offset value of 3 dB, the WTRU transmits the UL burst at 18 dBm. The network has the choice of mandating the offset value to higher order modulation, higher symbol rate or the combination of the two. Alternatively, a cell hopping layer may be also be used that prevents assignment of resources on a BCCH frequency where higher power is typically used. Alternatively, the BCCH channels may be used with an appropriate power offset value applied to EGPRS-2 transmissions.

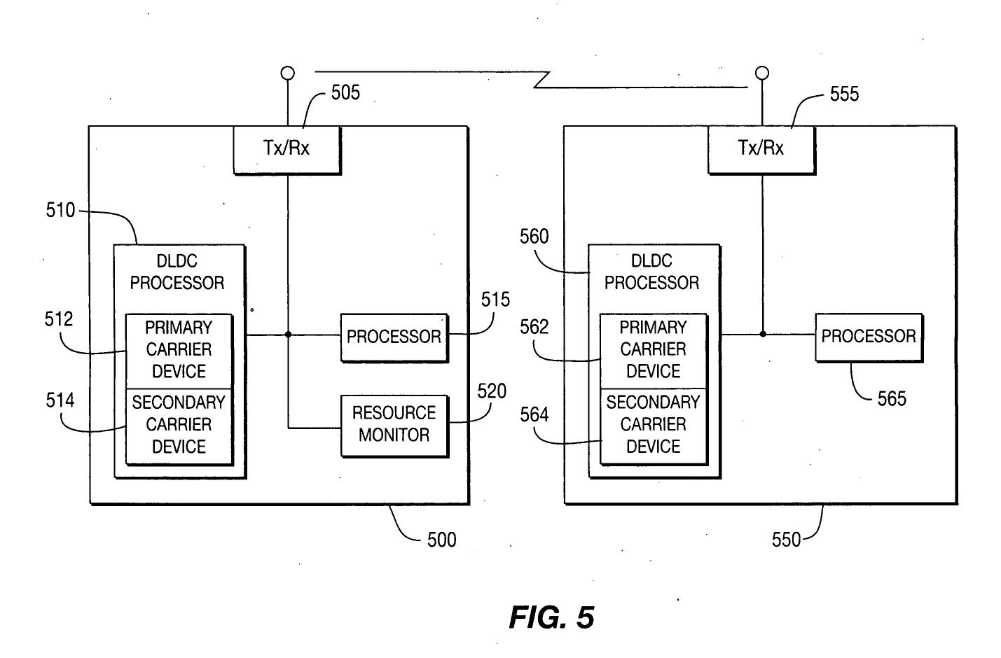

Referring to FIG. 5, a WTRU 500 includes a transceiver 505, a DLDC processor 510 including a primary carrier device 512 and a secondary carrier device 514, a processor 515, and a resource monitor 520. The DLDC processor 510, in combination with the transceiver 505, is configured to implement various DLDC modes such as those known in the art as well as those described herein with reference to FIG. 3. The primary carrier device 512 and secondary carrier device 514 are configured to monitor the primary and secondary carriers when in DLDC modes. The DLDC processor 510 is configured to select and switch between the primary carrier device 512 and the secondary carrier device 514 to implement the methods disclosed herein. The resource monitor 520 is configured to monitor available WTRU resources, and in combination with the processor 515, is configured to generate dynamic device capability messages as disclosed herein. The processor 515 is configured, in combination with the transceiver, to generate and transmit, and receive and process, various messages disclosed herein including dynamic device requirement messages and MS Classmark IEs.

Still referring to FIG. 5, a base station 550 includes a transceiver 555, a DLDC processor 560 including a primary carrier device 562 and a secondary carrier device 564, and a processor 565. The DLDC processor 560, in combination with the transceiver 555, is configured to implement various DLDC modes such as those known in the art as well as those described herein with reference to FIG. 3. The primary carrier device 562 and the secondary carrier device 564 are configured to generate the primary and secondary carrier, respectively. In combination with the DLDC processor 560, the primary carrier device 562 and the secondary carrier device 564 implement the methods disclosed herein for DLDC operation with reference to FIG. 3. The control and selection of the primary carrier device 562 and the secondary carrier device 564 are handled by the DLDC processor 560. The processor 565, in combination with the transceiver 555, receives and processes various capability messages, including MS Classmark information elements and dynamic device capability messages as disclosed herein. Processor 565 is further configured to allocate resources based on the received capability messages, again as disclosed herein.

Although the features and elements are described in the embodiments in particular combinations, each feature or element can be used alone without the other features and elements or in various combinations with or without other features and elements. The methods or flow charts disclosed may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for use in a wireless transmit/receive unit (WTRU), the method comprising:
calculating a power level for transmitting uplink data to a base station;
selecting a modulation scheme for modulating the uplink data;
adjusting an uplink transmission power level according to a power offset value in response to a selection of a high order modulation scheme; and
transmitting the uplink data at the adjusted uplink power level.

2. The method of claim 1, further comprising:
receiving a message from a base station including the power offset value.

3. The method of claim 2, wherein the message is received over a broadcast control channel (BCCH).

4. A wireless transmit/receive unit (WTRU) comprising:
a processor configured to:
calculate a power level for transmitting uplink data to a base station;
select a modulation scheme for modulating the uplink data; and
adjust an uplink transmission power level according to a power offset value in response to a selection of a high order modulation scheme; and
a transmitter configured to transmit the uplink data at the adjusted uplink power level.

5. The WTRU of claim 3, further comprising:
a receiver configured to receive a message from a base station including the power offset value.

6. The WTRU of claim 5, wherein the message is received over a broadcast control channel (BCCH).

7. A method for use in an enhanced general packet radio service 2 (EGPRS-2) wireless transmit/receive unit (WTRU), the method comprising:
determining a general packet radio service (GPRS) multi-slot class of the WTRU;
determining an EGPRS-2 multi-slot capability of the WTRU;
generating a message containing an indication of a difference between the determined GPRS multi-slot class of the WTRU and the determined EGPRS-2 multi-slot capability of the WTRU; and
transmitting the message to a base station.

8. The method of claim 7, wherein the EGPRS-2 multi-slot capability of the WTRU relates to a reduced symbol duration, higher order modulation and turbo coding (REDHOT) feature.

9. The method of claim 7, wherein the EGPRS-2 multi-slot capability of the WTRU related to a higher uplink performance for GERAN evolution (HUGE) feature.

10. A wireless transmit/receive unit (WTRU) comprising:
a processor configured to:
determine a general packet radio service (GPRS) multi-slot class of the WTRU; and
determine an EGPRS-2 multi-slot capability of the WTRU;
a message generator configured to generate a message containing an indication of a difference between the determined GPRS multi-slot class of the WTRU and the determined EGPRS-2 multi-slot capability of the WTRU; and
a transmitter configured to transmit the message to a base station.

11. The WTRU of claim 10, wherein the EGPRS-2 multi-slot capability of the WTRU relates to a reduced symbol duration, higher order modulation and turbo coding (REDHOT) feature.

12. The WTRU of claim 10, wherein the EGPRS-2 multi-slot capability of the WTRU related to a higher uplink performance for GERAN evolution (HUGE) feature.

13. A method for use in a downlink dual carrier (DLDC) capable wireless transmit/receive unit (WTRU), the method comprising:
monitoring a primary carrier for a transmission format indicator (TFI) associated with the WTRU while a secondary carrier remains idle;
in response to receiving a TFI associated with the WTRU on the primary carrier, activating the secondary carrier; and
receiving downlink data on both the primary carrier and the secondary carrier.

14. The method of claim 13, wherein receiving downlink data on both the primary carrier and the secondary carrier commences after an offset in time from receiving a TFI associated with the WTRU.

15. The method of claim 14, wherein the offset is a number of radio blocks after receiving a TFI associated with the WTRU, and the offset is received in a message from a base station.

16. A wireless transmit/receive unit (WTRU) capable of downlink dual carrier (DLDC) operation, the WTRU comprising:
a receiver configured to receive downlink transmissions from a base station over a primary carrier and a secondary carrier;
a DLDC processor configured to monitor a transmission received over the primary carrier to detect a transmission format indicator (TFI) associated with the WTRU;
in response to detecting a TFI associated with the WTRU, the DLDC processor is further configured to process a transmission received over the secondary carrier.

17. The WTRU of claim 16, wherein the DLDC processor is further configured to wait for an offset in time after detecting a TFI associated with the WTRU before processing a transmission received over the secondary carrier.

18. The WTRU of claim 17, wherein the receiver is further configured to receive a message including the offset from a base station, wherein the offset is a number of radio blocks after detection of a TFI associated with the WTRU.
